(19) United States
(12) Patent Application Publication
(10) Pub. No.: US 2007/0177651 A1
(43) Pub. Date: Aug. 2, 2007

(54) Body temperature measuring device for helmet or head gear

(76) Inventors: Edward P. Daugherty, Birmingham, AL (US); Craig Daugherty, Birmingham, AL (US)

Correspondence Address: US CORPORATIONS, INC., P.O. BOX 234265, ENCINITAS, CA, 92023, US

(21) Appl. No.: 11/344,476

(22) Filed: Jan. 31, 2006

(51) Int. Cl. G01K 7/00

(52) U.S. Cl. 374/163

(57) ABSTRACT

A portable continuous body temperature monitoring device for a helmet or head gear to be worn by athletes, sports enthusiasts and workers in hot environments that is composed of a therimstor located in a position that is in contact with the temple or forehead of the wearer through attached head gear, pads or straps. The device also contains wiring for an LCD readout and a computer chip for algorithm and analysis of body temperature, signaling the device to trigger an alarm that is either auditory or visual. The computer chip also contains a correlation algorithm for accurate interpretation of body surface temperatures. The device is powered through a button battery and provides protection for dangerous rises in the body temperature of the wearer. The device can also contain electrodes in direct contact with the forehead of the wearer in order to monitor heart rate.

### FIELD OF THE INVENTION

This invention relates to the field of body temperature measuring devices, specifically to a device that can monitor the temperature of a person wearing a helmet or head gear, whether that person wears a helmet, hat or headband, or whether that person is an athlete, perhaps playing football or riding a bicycle, or a physical labor worker who is working under hot conditions.

### BACKGROUND OF THE INVENTION

We are reminded regularly of the dangers imposed from exercise and work in hot environments. It is an unfortunate fact that even young conditioned athletes and military recruits are afflicted with heat illness and death with fairly predictable regularity. Despite the knowledge of this problem and high profile deaths, the incidence of heat related deaths persists. Even persons that are not working or exercising in heat are susceptible to the illness it can create.

The elderly are significantly less able to tolerate heat stress and, every year, somewhere in the world, we find reports of elderly persons dying in non-air conditioned homes during summer heat waves. Children and adolescent athletes, due to their higher metabolic rates, smaller body surface index, body composition and diminished capacity for sweating (compared to adults) are more susceptible to heat related illness. Children also may not be as likely to properly hydrate themselves during periods of heat stress.

The monitoring of body temperature is very important in ensuring that the physical health of a person is stable if that person is exposed to extreme temperatures, particularly elevated temperatures. Unfortunately, certain conditions may exist which cause a dangerous elevation in a person's body temperature that has heretofore been largely undetectable until a physical response occurs that can be harmful and sometimes fatal to the person, such as dizziness, fainting and, in extreme cases, cardiac arrest. This can occur when an athlete is training in hot weather and is unable to cool his or her body down, such as when covered in large padding while playing football in the sun. Similarly, a person who pushes him or herself beyond the point that his or her physical conditioning would safely allow can experience a rapid rise in body temperature without realizing it.

This kind of experience can also occur with a worker who works under hot conditions, such as a construction worker. In the field of firefighting, the need for temperature monitoring is obvious and has been addressed in the prior art. In U.S. Pat. No. 6,075,445 by McLoughlin, et al., a high-temperature warning unit is disclosed that is attached to the firefighter's helmet. This device utilizes an LED readout on the helmet to warn of unsafe ambient temperatures. This device allows for a warning to the firefighters when the temperature around them gets dangerously hot. However, this device does not detect when the firefighter's own body temperature becomes dangerously hot, as this is usually not a problem because the firefighter is equipped with protective clothing. The problem of dangerous body temperature increases by athletes, sports enthusiasts and other workers in hot, but not fiery environments is not solved by the McLoughlin invention.

More closely related to the instant invention, Apisdorf teaches in U.S. Pat. No. RE36,242 of a helmet-mounted air system for the personal comfort of a worker in a hot atmosphere. This invention, however, is not a body temperature-monitoring device. The Apisdorf invention provides a device constructed for the purpose of flowing air unidirectionally downwardly across the face of a worker to keep him or her cool. This device keeps a worker cool by providing cool air from the worker's helmet to flow, cooled, across the worker's face, but it does not monitor the wearer's own body temperature.

Similar to the Apisdorf invention, Elkins et a. teach in U.S. Pat. No. 4,691,762 of a personal temperature control system. This invention involves a first heat exchanger adapted to be worn as a garment and a second heat exchanger adapted to interact with a temperature source. This invention involves a vest and a helmet. This system is primarily an insulation system and does not serve to monitor the body temperature of the wearer to detect overheating.

Until now, there has not been a portable, readily available, easy to use and affordable device that monitors body temperature over an extended period of time in a non-hindering arrangement while also providing an alarm warning of dangerous temperature and/or heat rate elevation. Accordingly, there exists an unmet need for a device that can easily monitor the body temperature of an athlete or worker who is susceptible to dangerous increases in body temperature while performing athletically or while on the job.

### SUMMARY OF THE INVENTION

In the preferred embodiment of the invention, the body temperature of a person can be continuously measured with a portable device that is attached to any type of helmet or head gear. The device contains a thermistor, which is a resistor, whose resistance changes with temperature. Because of the known dependence of resistance on temperature, the resistor can be used as a temperature sensor. The thermistor is located adjacent to and in contact with the body of the wearer, i.e., it is held in one of the interior pads of the helmet or head gear. The thermistor has metal wiring attached that connects it to an LCD readout, located on the helmet or head gear that reads the body temperature of the wearer, acting as an early warning indicator should the wearer's body temperature get dangerously high. The LCD readout allows for the monitoring of body temperature, but the device can also be programmed to trigger an audible or visual alarm acting as a warning signal.

The device is battery powered, specifically powered by a button battery. The device contains a computer chip allowing temperature measures of either Fahrenheit or Celsius, a target temperature alarm which can be programmed to trigger an audible signal, such as an audible beep, or visual signal, such as the LCD readout or a flashing light, at a pre-selected high temperature and a surface temperature to core body temperature conversion algorithm.

Direct contact electrodes along the forehead could be added to monitor heart rate. The same alarm devices used to notify of high body temperatures could be used to warn of excessive heart rates. A digital data display could provide real time monitoring of both body temperature and pulse. Small monitoring electrodes and the thermistor can be implanted into either the inner brim of a hat or cap or into the forehead pads of a helmet or into a headband.

The instant invention is a small, lightweight, portable, self-contained and self-sustaining unit. It is designed to function on a person's head or may be incorporated into headgear. Actual body surface temperature and/or core body temperature algorithms, along with heart rate, can be monitored. Alarms can be set for a user at a selected level of temperature and heart rate.

### OBJECT OF THE INVENTION

The principal object of the invention is to provide an early warning indicator to persons who are susceptible through their activities to a dangerous rise in body temperature, such as athletes, sports enthusiasts and workers in hot conditions.

It is another object of the invention that the device be portable.

It is another object of the invention that the device continuously measures the body temperature of the wearer.

It is another object of the invention that it be easy to use.

It is another object of the invention that it be reliable.

It is another object of the invention that it be lightweight.

It is another object of the invention that it be comfortable.

It is another object of the invention that it has low initial cost and low maintenance cost.

It is another object of the invention that it be able to withstand the demands of contact sports.

It is another object of the invention that it monitor and display body temperature in either degrees Fahrenheit or degrees Celsius.

It is another object of the invention that it produce actual forehead temperature of the wearer or us an algorithm to calculate core body temperature.

It is another object of the invention that it monitors the heart rate of the user.

It is another object of the invention that it enables the user to select an alarm with an audible or a visual signal.

### BRIEF DESCRIPTION OF THE DRAWINGS

FIG. 1 illustrates a front view of the device on the head of the wearer in a helmet arrangement.

FIG. 2 illustrates a front view of the device on the head of the wearer in a headband arrangement.

FIG. 3 illustrates a perspective view of the device, as it would be incorporated into a football helmet.

FIG. 4 illustrates a schematic representation of the circuit connections inside of the main device.

FIG. 5 illustrates a schematic representation of the temperature monitoring system.

FIG. 6 illustrates a connected view of the temperature monitoring system from the sensor to the display.

FIG. 7 illustrates the view of the circuitry inside of the enclosure.

### DETAILED DESCRIPTION OF AN ENABLING AND PREFERRED EMBODIMENT

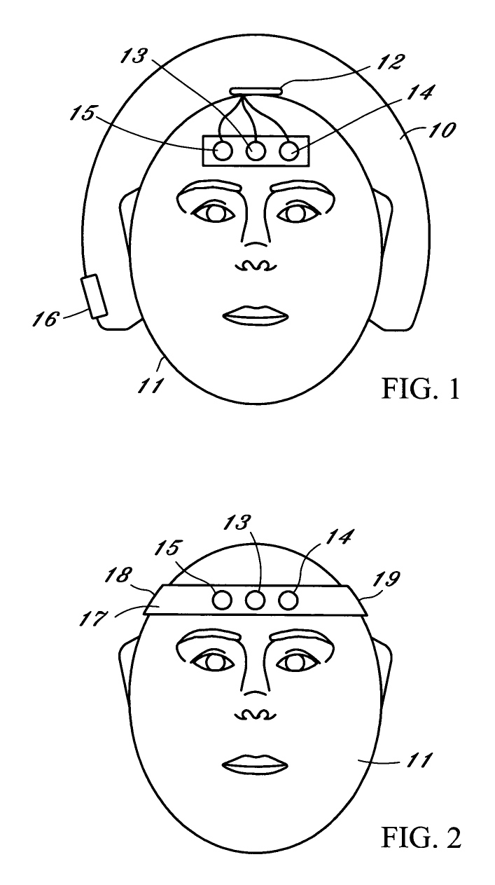

For a better understanding of the invention, we turn now to the drawings. FIG. 1 offers a view of the device as used in a helmet 10 arrangement on top of the head of the wearer 11. Located on the forehead is the monitor 12 portion of the device. The monitor 12 is connected through wires to the thermistor 13 that contains a positive electrode 14 and a negative electrode 15. Located on the outer portion of the helmet 10 is a display 16 with an alarm.

FIG. 2 offers a view of the device as used in headband 17 arrangement on top of the head of the wearer 11. Similar to the helmet arrangement, the device contains a thermistor 13 with a positive electrode 14 and a negative electrode 15. The headband arrangement has a on it a monitor with an alarm 18 and LCD display 19.

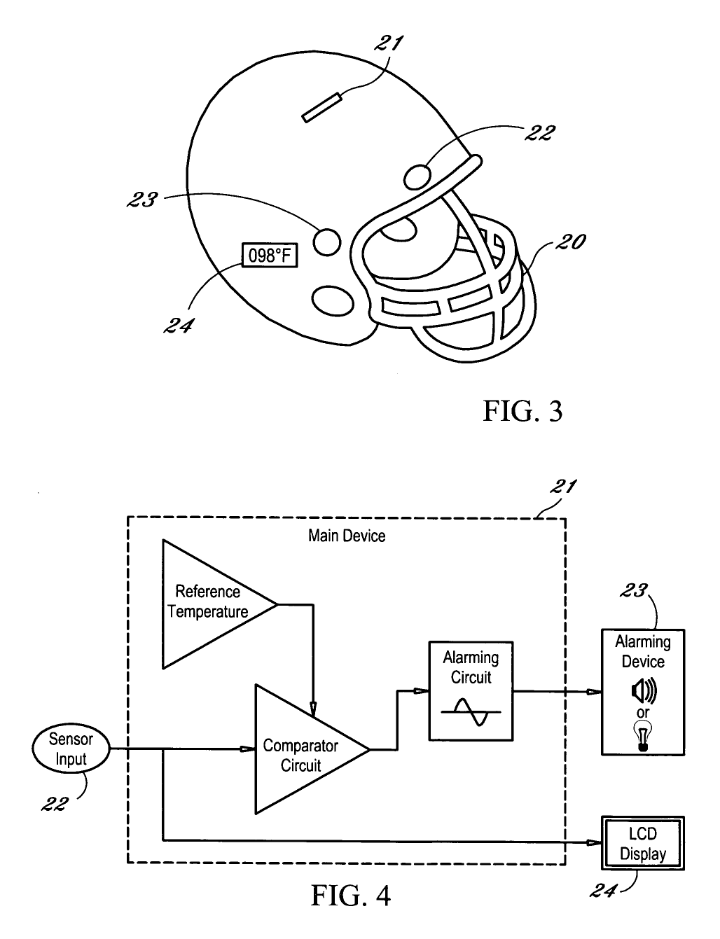

FIG. 3 offers an outside view of the device when in use on a football helmet 20. The main device 21 is located on the top of the helmet 20. A temperature sensor 22 is located near the forehead of the wearer. On the outside of the helmet 20 is an alarming device 23 and a display 24. The main device 21 is mounted in the void space on the top of the helmet 20. The temperature sensor 22 is mounted on the pad that stays in contact with the forehead constantly. The display 24 is mounted on the side towards the back of the helmet 20. Special care is taken for the placement of the device 21 and all of the components on the helmet 20 so as to lessen the probability of impact with other objects during use.

The main device 21 is illustrated in further schematic detail in FIG. 4. FIG. 4 shows the different circuits inside the main device 21 and also shows its connections with the sensor 22, the alarming device 23 and the LCD display 24.

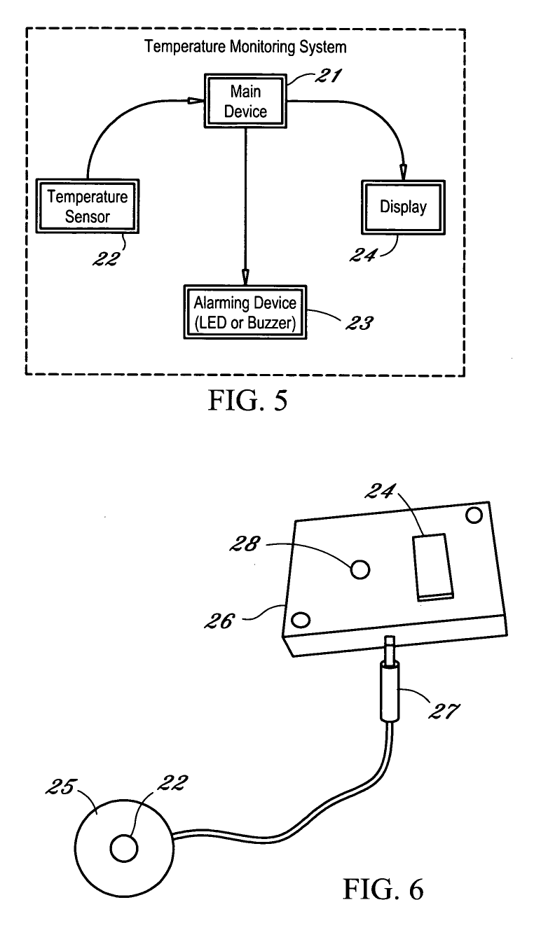

FIG. 5 is a schematic view of the entire device. The main device 21 encloses the circuitry for accepting the temperature readings from the temperature sensor 22. The sensor 22 provides skin temperature readings from the forehead of the user. The main device 21 has the circuitry to calculate the core body temperature of the user and display it on the LCD display 24. The main device 21 also contains the circuitry for producing an alarm signal when the core body temperature reaches a critical threshold and will be relayed by the alarming device 23. The critical threshold is programmed into the alarm circuitry of the main device 21.

FIG. 6 is a detailed view of the temperature monitoring system. The sensor 22 is attached to the chosen head device with adhesive tape 25. The sensor 22 is connected to the circuit board 26 enclosure with display mounted on it through wiring 27. On the circuit board enclosure 26 is an LCD display 24 and an LED indicator 28.

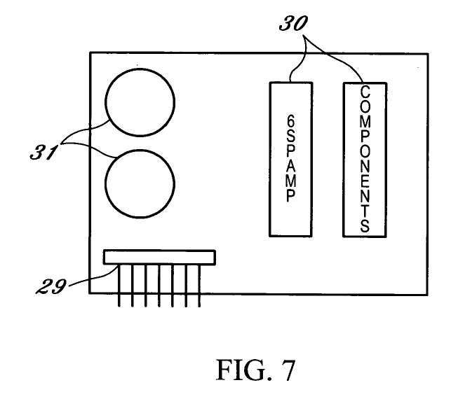

FIG. 7 illustrates the inside of the circuit board 26 enclosure. There are connections 29 for the sensor 22 and LCD display 24. Located inside the enclosure 26 is the circuitry 30 for the LED alarm and threshold adjustment. Two three-volt batteries 31 support the display and LED alarm circuitry.

The illustrations and examples provided herein are for explanatory purposes and are not intended to limit the scope of the appended claims, as those skilled in the art will make modifications to the invention for particular uses.

I claim:

1. A portable continuous body temperature-monitoring device for attachment to a helmet or head gear comprising
means for sensing the body temperature of the person wearing said helmet;
means for interpreting said body temperature of said person wearing said helmet;
means for reading said sensed temperature;
means for activation of a warning signal;
means for transmitting electricity between said temperature sensing means and said reading means;
a power source.

2. A portable continuous body temperature-monitoring device according to claim 1 wherein said means for sensing body temperature is a thermistor containing a positive electrode and a negative electrode.

3. A portable continuous body temperature-monitoring device according to claim 1 wherein said electricity transmitting means are metal wires.

4. A portable continuous body temperature-monitoring device according to claim 1 wherein said temperature reading means is an LCD readout.

5. A portable continuous body temperature-monitoring device according to claim 1 wherein said power source is a button battery.

6. A portable continuous body temperature-monitoring device according to claim 1 wherein said means for interpreting the body temperature of the person wearing the helmet or head gear comprises an LCD readout that is controlled by a computer chip that permits the conversion algorithm of surface temperature to core body temperature, the selection of Fahrenheit or Celsius, and the selection of the target body temperature that triggers a warning signal.

7. A portable continuous body temperature-monitoring device according to claim 1 wherein said means for activation of a warning signal comprises an LED readout.

8. A portable continuous body temperature-monitoring device according to claim 1 wherein said means for activation of a warning signal comprises an audible beep.

9. A portable continuous body temperature-monitoring device according to claim 1 wherein said means for activation of a warning signal comprises a flashing light.

10. A portable continuous body temperature-monitoring device according to claim 1 wherein direct contact electrodes are added to be placed against the forehead of the wearer in order to monitor heart rate.
